(19) United States
(12) Patent Application Publication
(10) Pub. No.: US 2012/0253527 A1
(43) Pub. Date: Oct. 4, 2012

(54) Programming Simulator for an HVAC Controller

(75) Inventors: Alan HIETALA, Toronto (CA); Liu YANG, Cambridge (CA)

(73) Assignee: ECOBEE, INC., Toronto (CA)

(21) Appl. No.: 13/176,031

(22) Filed: Jul. 5, 2011

(30) Foreign Application Priority Data
Apr. 4, 2011 (CA) 2735614

(51) Int. Cl. G05D 23/00; G05B 15/00; G05B 13/04

(52) U.S. Cl. 700/278; 700/276

(57) ABSTRACT

A programming simulator is provided, being adapted to run on one of a controller for HVAC equipment operable to communicate across a network, and a remote device operable to communicate with the controller through the network. The programming simulator is operable to display the current value of energy usage by the HVAC equipment on the premise over the period of time and also display at least one changeable parameter, the at least one changeable parameter relating to energy usage. Upon selection of the at least one changeable parameter, displaying a simulator value, the simulator value proving an estimate of energy usage over the same period of time as the current value using the selected at least one changeable parameter in the energy model.

### FIELD OF USE

The present invention relates to HVAC equipment. More specifically, the present invention relates to predicting the consumption of energy by the HVAC equipment.

### BACKGROUND

Solutions for efficient management of enterprise energy usage, such as for heating and cooling, contribute not only to reduced energy costs, but also result in a positive environmental impact and a reduced carbon footprint. To the extent that those solutions or tools are made easier and more convenient for a user, more widespread adoption of those solutions or tools should result, and thus promotes energy conservation.

US Patent Application 2009-0099699A1 (published 2009 Apr. 16) to Steinberg and Hulou discloses systems and methods for verifying the occurrence of a change in operational status for climate control systems. The climate control system measures temperature at least a first location conditioned by the climate control system. One or more processors also receive measurements of outside temperatures from at least one source other than the climate control system, and compares the temperature measurements from the first location with expected temperature measurements. The expected temperature measurements are based at least in part upon past temperature measurements obtained by the climate control system and the outside temperature measurements. A server transmits changes in programming to the climate control system based at least in part on the comparison of the temperature measurements with the expected temperature measurements.

### SUMMARY

According to a first embodiment of the invention, there is provided an integrated climate control system, comprising:
a controller operable to control HVAC equipment on a premise, the controller further being operable to transmit runtime data and receive operation instructions across a network;
an environmental web service, the environmental web service being operable to communicate across the network with the controller, the environmental web service being able to receive the runtime data from the controller and further transmit operation instructions to the controller relating to the control of the HVAC equipment on the premise across the network; and
an energy modelling server, the energy modelling server being adapted to store the runtime data received from the controller, and is further operable to run an energy model that is operable to calculate a current value of energy usage by the HVAC equipment on the premise over a period of time.

According to another embodiment of the invention, there is provided: a programming simulator, adapted to run on one of a controller for HVAC equipment operable to communicate across a network, and a remote device operable to communicate with the controller through the network, the programming simulator being operable to:
display the current value of energy usage by the HVAC equipment on the premise over the period of time;
display at least one changeable parameter, the at least one changeable parameter relating to energy usage; and
upon selection of the at least one changeable parameter, displaying a simulator value, the simulator value proving an estimate of energy usage over the same period of time as the current value using the selected at least one changeable parameter in the energy model.

### BRIEF DESCRIPTION OF THE DRAWINGS

Embodiments will now be described by way of example only, with reference to the following drawings in which:

FIG. 1 is a schematic illustrating an embodiment of an integrated climate control system (ICCS) comprising an environmental web server, a controller for HVAC equipment and one or more remote devices, all communicatively coupled via a network;

FIG. 2 is a front plan view of the controller shown in FIG. 1, and illustrates some of the external features, screen display and programs executable on the controller;

FIG. 3 is a schematic illustrating an electronic architecture of the controller shown in FIG. 1;

FIG. 4 is a front plan view of one of the remote devices shown in FIG. 1, the remote device having a replica screen of the screen display of the environmental control device illustrated in FIG. 2;

FIG. 5 is an illustration of a scheduling program running on either the controller or remote device shown in FIG. 1, the scheduling program displaying a plurality of time periods used to schedule different set points for the HVAC equipment;

FIG. 6 is an illustration of a programming simulator running on the controller or remote device shown in FIG. 1, the programming simulator being able to display changes in energy consumption based upon hypothetical changes made to the premise or HVAC equipment usage;

FIG. 7 is an illustration of a communication sequence chart showing communication between the controller and the environmental web server shown in FIG. 1, the two cooperatively running the programming simulator shown in FIG. 6;

FIG. 8 is an illustration of a communication sequence chart showing communication between the remote device, the environmental web server and the controller shown in FIG. 1, the three cooperatively running the programming simulator shown in FIG. 6;

FIG. 9 is an illustration of another embodiment of the programming simulator running on the controller or remote device shown in FIG. 1;

FIG. 10 is an illustration of another embodiment of the programming simulator running on the controller or remote device shown in FIG. 1;

FIG. 11 is an illustration of a comparative function used by one of the programming simulators of FIGS. 5-10 used to compare the energy efficiency of the premise relative to other similar premises; and

FIG. 12 is a schematic illustrating an architecture of an energy model running on an energy modelling server shown in FIG. 1.

### DETAILED DESCRIPTION

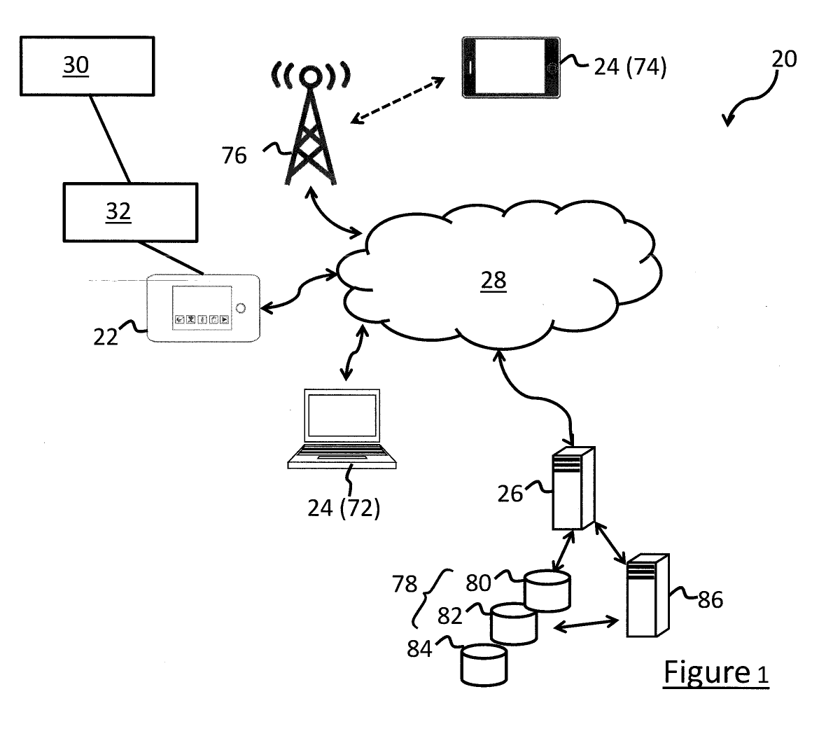

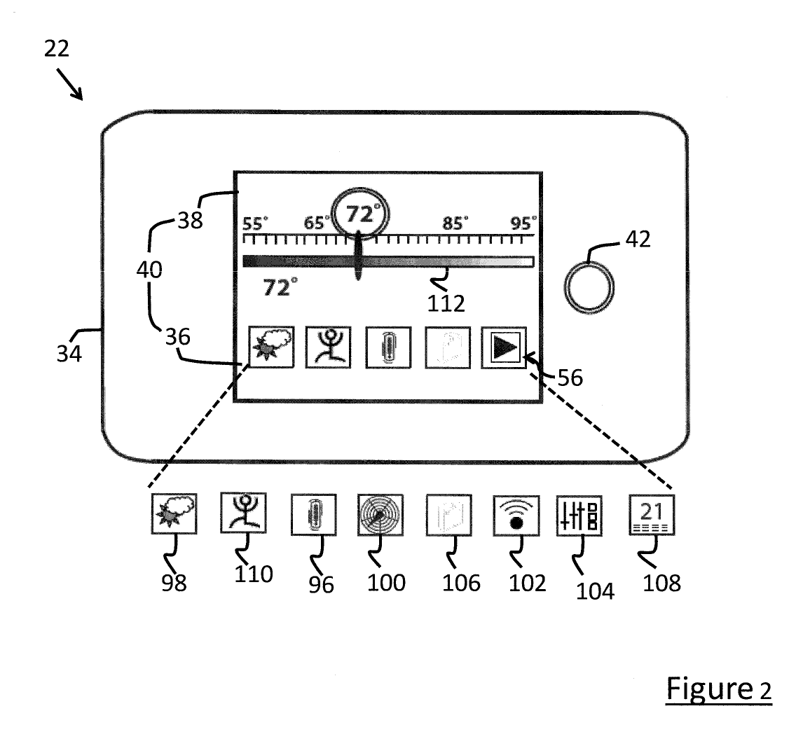

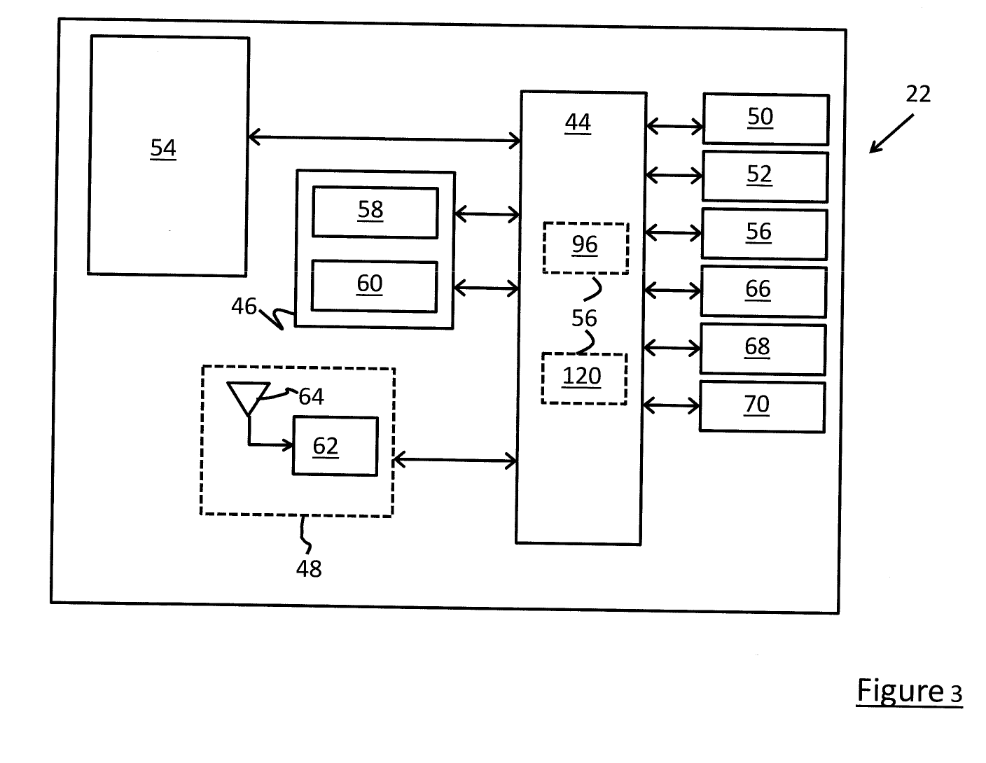

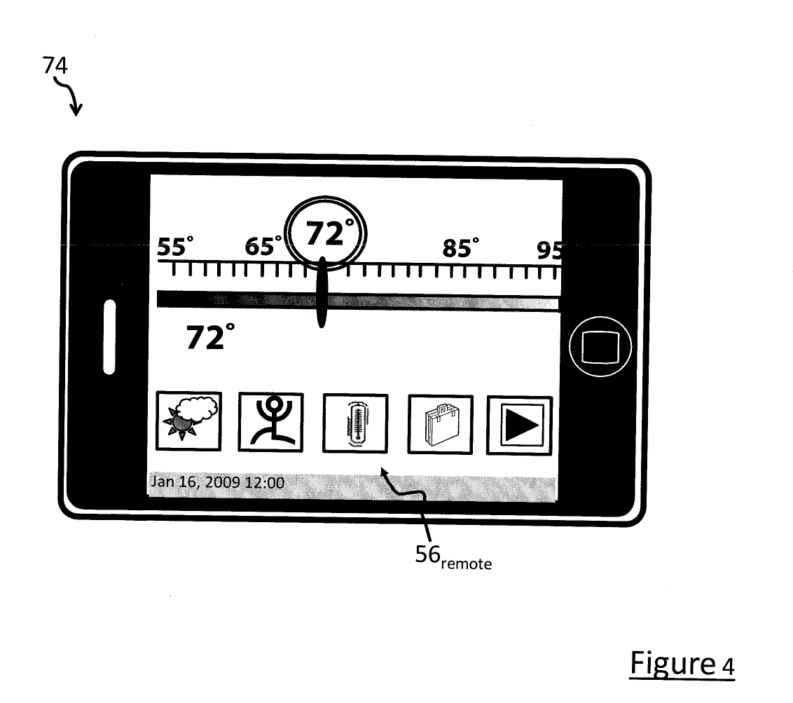

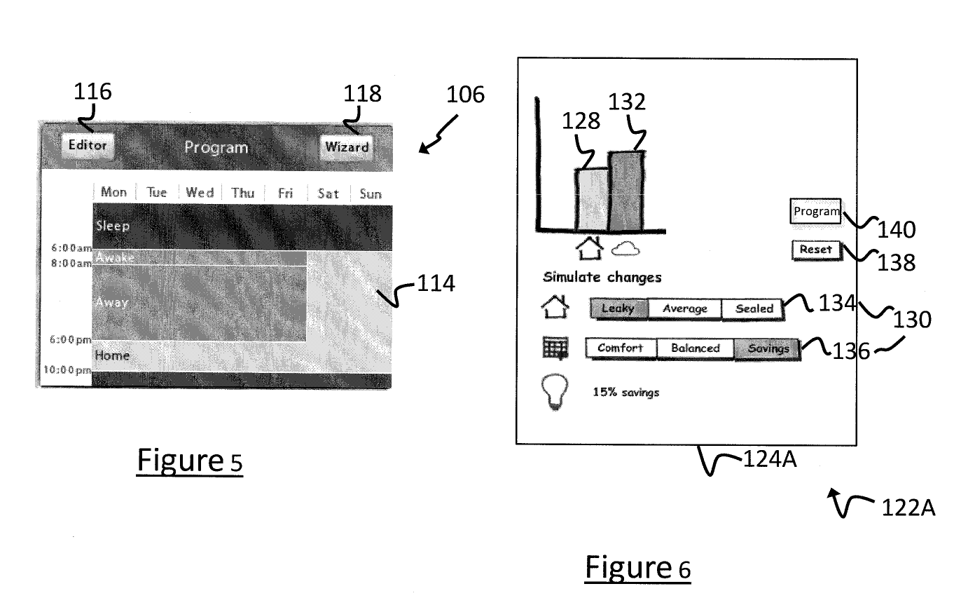

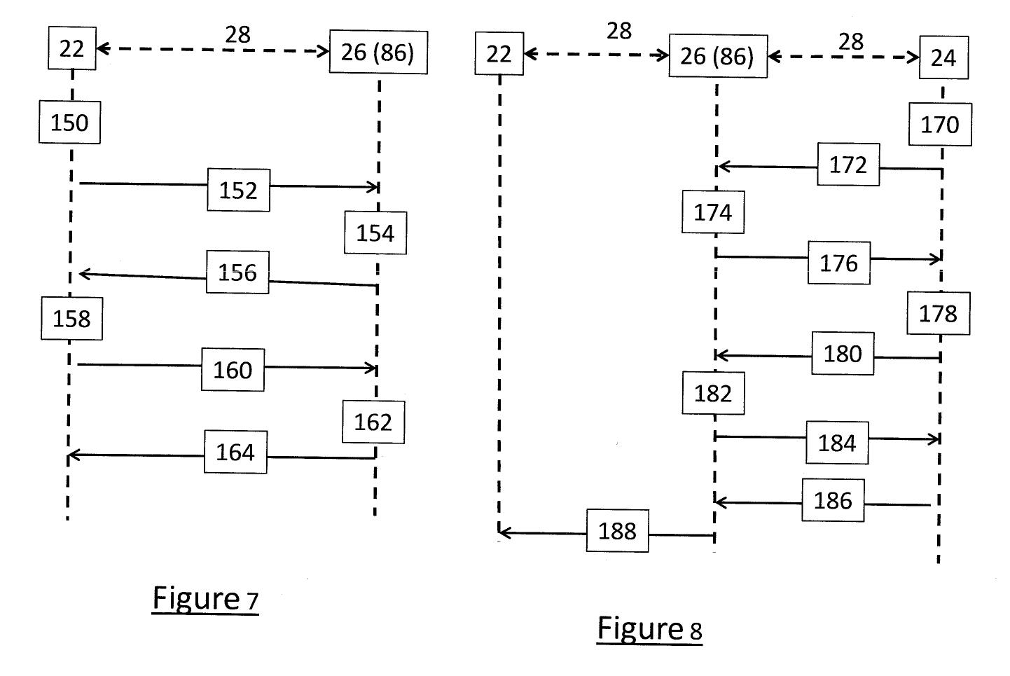

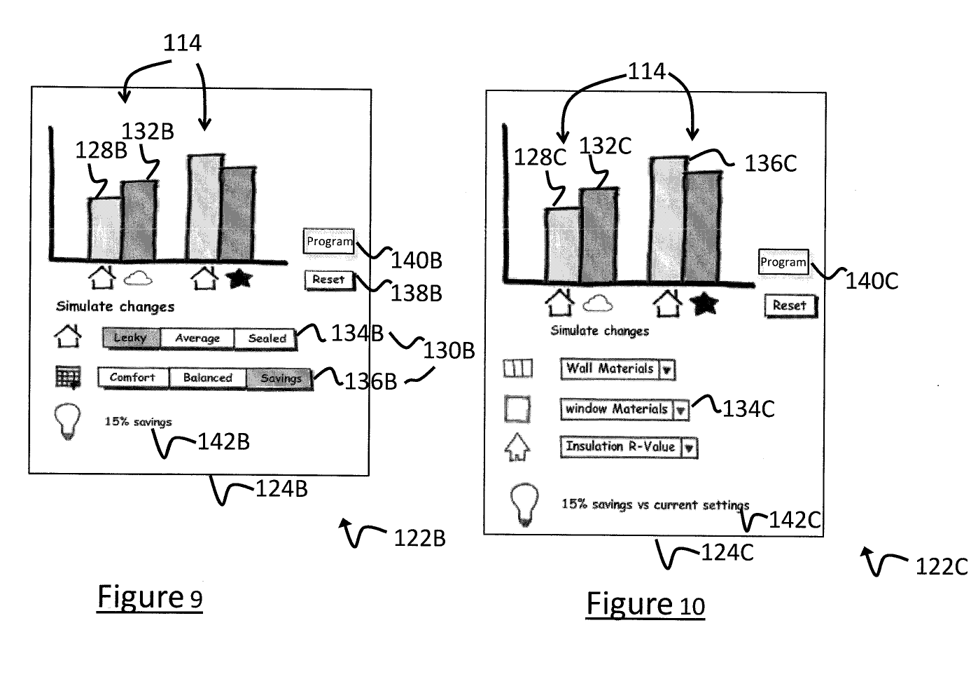

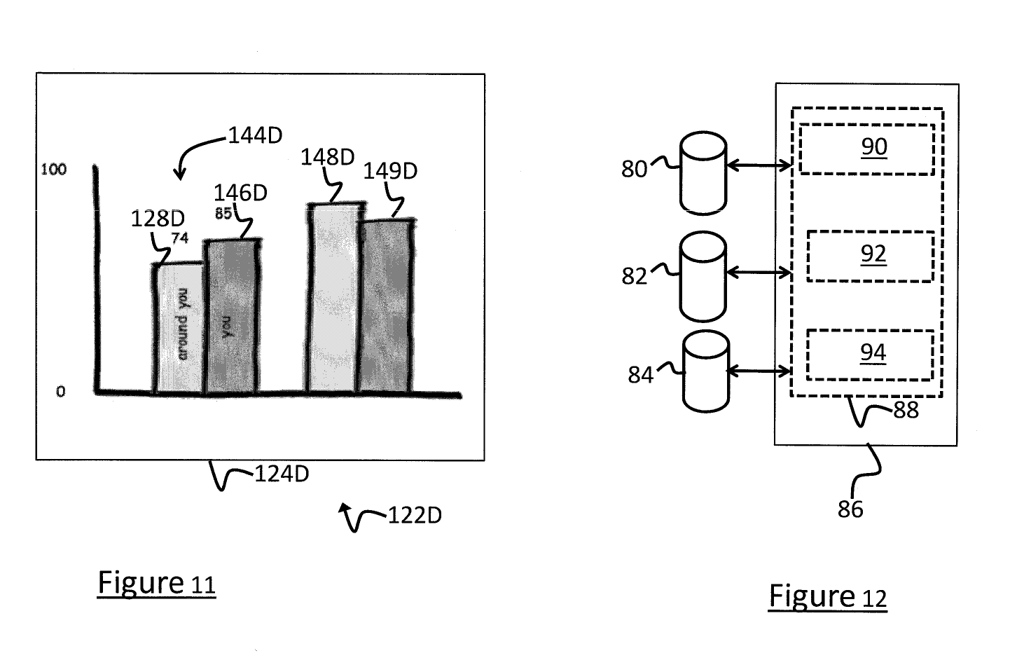

Referring now to FIG. 1, an integrated climate control system (ICCS) is shown generally at 20. ICCS 20 includes a controller 22, at least one remote device 24, and an environmental web service 26, the three being in communication with each other at least periodically via a network 28. Network 28 can include different, interconnected networks such as a private network (often a private WiFi network) in communication with the public Internet.

Controller 22 is typically installed and located within a home, an enterprise or other building premise, and is adapted to control HVAC equipment 30, which is typically also located on the premise. Controller 22 is often colloquially referred to as a ‘smart thermostat’, but of course may also regulate HVAC functions other than temperature. HVAC equipment 30 can include furnaces, air conditioning systems, fans, heat pumps, humidification/dehumidification systems and the like. Controller 22 can be connected to HVAC equipment 30 using a hard-line connection (such as a 4-wire connector), a wireless connection, or a combination of the two. In some configurations, an equipment interface module (EIM) 32 can be provided as an interface between the controller 22 and HVAC equipment 30. The EIM 32 receives commands from the controller 22 across the hard-line or wireless connection, and then activates or deactivates the relays required to control the HVAC equipment 30. In addition, the EIM 32 includes detectors operable to monitor the operational status of HVAC equipment and transmit error codes and conditions back to controller 22.

Referring now to FIG. 2, controller 22 is described in greater detail. Controller 22 includes a housing 34, at least one input 36 adapted to receive user commands and an output 38 that is adapted for displaying environmental, operational, historical and programming information related to the operation of HVAC equipment 30. Input 36 can include fixed-function hard keys, programmable soft-keys, or programmable touch-screen keys, or any combination thereof. Output 38 can include any sort of display such as a LED or LCD screen, including segmented screens. Of course, input 36 and output 38 can be combined as a touch-screen display 40. The sensing technologies used by touch-screen display 40 may include capacitive sensing, resistive sensing, surface acoustic wave sensing, pressure sensing, optical sensing, and the like. In the presently-illustrated embodiment, controller 22 includes a 3.5″ TFT touch screen display 40 using resistive sensing, which provides the functionality for both input 36 and output 38. In addition, controller 22 includes a hard key 42 (i.e., the “home” button) as an additional input 36 option.

Referring now to FIG. 3, the internal components of controller 22 are shown in greater detail. In the presently-illustrated embodiment, controller 22 includes a processor 44, memory 46, a radio frequency (RF) subsystem 48, I/O interface 50, power source 52 and environmental sensors 54.

Processor 44 is adapted to run various applications 56, many of which are displayed on touch screen display 40 (FIG. 2) on controller 22. Details on applications 56 are provided in greater detail below. In presently-illustrated embodiment, processor 44 is a system on a chip (SOC) running on an ARM processor. Processor 44 can include additional integrated functionality such as integrating a touch-screen controller or other controller functions. Those of skill in the art will recognize that other processor types can be used for processor 44. Memory 46 includes both volatile memory storage 58 and non-volatile memory storage 60 and is used by processor 44 to run environmental programming (such as applications 56) and store operation and configuration data. In the presently-illustrated embodiment, the volatile memory storage 58 uses SDRAM and the non-volatile memory storage 60 uses flash memory. Stored data can include programming information for controller 22 as well as historical usage data, as will be described in greater detail below. Other types of memory 46 and other uses for memory 46 will occur to those of skill in the art.

RF subsystem 48 includes a Wi-Fi chip 62 operably connected to a Wi-Fi antenna 64. In the presently-illustrated embodiment, Wi-Fi chip 62 support 802.11b/g communication to a router within range that is connected to network 28. As currently-illustrated, Wi-Fi chip 62 supports encryption services such as WPA, WPA2 and WEP. Other networking protocols such as 802.11a or n, and 802.16 (WiLan), as well as other encryption protocols are within the scope of the invention. RF subsystem 48 can further include other wireless communication subsystems and controllers, such as cellular communication subsystems, Bluetooth subsystems, Zigbee subsystems or IR subsystems.

I/O interface 50 provides the physical connectors for controller 22. For example, I/O interface 50 may include the connectors for a 4-wire connection to HVAC equipment 30 (FIG. 1). I/O interface can also include a debug port, a serial port, DB9 pin connector, a USB or microUSB port, or other suitable connections that will occur to those of skill in the art. Power source 52 provides electrical power for the operation of controller 22 and can include both wire-line power supplies and battery power supplies. In the presently-illustrated embodiment, the four-wire connection to I/O ports 50 can also provide the necessary power for controller 22, as well as any necessary surge protection or current limiters. Power source 52 can also include a battery-based back-up power system. In addition, power source 52 may provide a power connection jack which allows the controller 22 to be powered on without being connected to the 4 wire connection, or relying upon battery backup.

In addition, controller 22 can include one or more expansion slots or sockets 66. The expansion slot/socket 66 is adaptable to receive additional hardware modules to expand the capabilities of controller 22. Examples of additional hardware modules include memory expansion modules, remote sensor modules, home automation modules, smart meter modules, etc. The expansion slot/socket 66 could include an additional RF component such as a Zigbee® or Zwave™ module. The home automation module would allow capabilities such as remote control of floor diffusers, window blinds, etc. The combination of remote sensing and remote control would serve as an application for Zoning temperature Zone control.

Environmental sensor 54 is adapted to provide temperature and humidity measurements to the processor 44. In the presently-illustrated embodiment, environmental sensor 54 is an integrated component, but could also be separate thermistors and hydrometers. It is contemplated that environmental sensor 54 could include additional sensing capabilities such as carbon-monoxide, smoke detectors or air flow sensors. Other sensing capabilities for environmental sensor 54 will occur to those of skill in the art.

Controller 22 can include additional features, such as an audio subsystem 68. The audio subsystem 68 can be used to generate audible alerts and input feedback. Depending on the desired features, audio subsystem 68 can be adapted to synthesize sounds or to play pre-recorded audio files stored in memory 46.

Another additional feature for controller 22 is a mechanical reset switch 70. In the presently-illustrated embodiment, mechanical reset switch 70 is a microswitch that when depressed either restarts the controller 22 or reinitializes the controller 22 back to its original factory condition.

Referring back to FIG. 1, other components of ICCS 20 are described in greater detail. The remote device 24 is adapted to be located remote from the controller 22 and can include either or both of: a personal computer 72 (including both laptops and desktop computers), and a mobile device 74 such as a smart phone, tablet or Personal Digital Assistant (PDA). The remote device 24 and more typically the mobile device 74 may be able to connect to the network 28 over a cellular network 76. As can be seen in FIG. 4, remote device 24 includes one or more remote applications 56ᵣₑₘₒₜₑ. As will be described in greater detail below, the remote applications 56ᵣₑₘₒₜₑ are akin to the applications 56 found on controller 22, and generally provide similar functionality. However, remote applications 56ᵣₑₘₒₜₑ may be reformatted to account for the particular display and input characteristics found on that particular remote device 24. For example, a mobile device 74 may have a smaller touch screen than is found on controller 22. It is also contemplated that remote applications 56ᵣₑₘₒₜₑ may have greater or reduced functionality in comparison to their counterparts, applications 56.

The remote device 24, and most typically the personal computer 72 may connect to network 28 using either a wire-line connection or a wireless connection, for example. The personal computer 72 can be loaded with an appropriate browsing application for accessing and browsing the environmental web service 26 via network 28. Personal computer 72 is operable to run one or more PC applications 56_{PC} (not illustrated), which can include web-based applications. As will be described in greater detail below, the PC applications 56_{PC} are akin to the applications 56 found on controller 22, and generally provide similar functionality. However, PC applications 56_{PC} are reformatted to account for the particular display and input characteristics found on personal computer 72. For example, a personal computer 72 may have a larger screen, and a mouse or touchpad input. It is also contemplated that PC applications 56_{PC} may have greater or reduced functionality in comparison to their counterparts, applications 56.

The environmental web service 26 may be owned by a separate organization or enterprise and provides web portal application for registered users (typically the owners of controllers 22). Environmental web service 26 acts as a web server and is able to determine and deliver relevant content to controllers 22 and to remote devices 24 (i.e., personal computers 62 and mobile devices 64). For example, environmental web service 26 may deliver applications 56, 56ᵣₑₘₒₜₑ and 56_{PC} to any accessing device using the appropriate internet protocols. In effect, environmental web service 26 allows the controller 22 to communicate with remote devices 24. Environmental web service 26 may also transfer data between its own content databases, controllers 22 and remote devices 24. Environmental web service 26 is further operable to enable remote or web-based management of controller 22 from a client using the aforementioned remote device 24. Environmental web service 26 provides the set of web widgets and that provides the user interface for users of remote devices 24. It is further contemplated that environmental web service 26 is operable to provide remote software updates to the applications 56 over network 28.

Environmental web service 26 may have access to one (or more) content database(s) 78. In the presently-illustrated embodiment, content databases 78 include customer account data 80, interval status data 82 and aggregate data warehouse 84.

Customer account data 80 can include subscriber information, location data, privacy settings and other user preferences. In addition, it can include contractor and manufacturer data, such as the contact information for the installer of HVAC equipment 30, and the model and installation date of the HVAC equipment 30 (furnace, air conditioner, etc.). Furthermore, customer account data 80 can include details about the customer premise. Customer premise details can include the style of the building (“detached”, “semi”, “apartment”, etc), the building size, number of floors, number of bedrooms, average number of occupants, age of the building, building materials, number of windows, window materials, insulation values, number of trees on premise, etc.). Other customer premise details will occur to those of skill in the art. Often, when a controller 22 is first installed on the premise, a contractor, owner or other person will configure their account using either the controller 22 or a remote device 24. The account set-up process provides an opportunity to collect customer premise details. This information can also be later updated by a user using a configuration program running on their controller 22 or remote device 24.

Interval status data 82 receives runtime data transmitted by for all controllers 22 connected to network 22. In the presently-illustrated embodiment, runtime data is collected in five-minute runtime buckets, and is described in greater detail below. To minimize network traffic on network 28, interval status data 82 can be used to update applications 56 running on remote devices 24 with the run-time data of controller 22. Using interval status data 82 in this fashion reduces the need to routing additional requests from remote devices 24 to and from controllers 22.

Aggregate data warehouse 84 is a data repository that aggregates the records stored in interval status data 82 and provides more efficient data structures for retrieving the information needed for energy reports and modelling. In the presently-illustrated embodiment, the interval status data is extracted, transformed into online analytical processing (OLAP) data cubes. The conversion of interval status data into OLAP data cubes can be performed by aggregate data warehouse 84 or by other components of environmental web service 26.

Environmental web service 26 may further includes an energy modelling server 86 that is operable to query aggregate data warehouse 84 and customer account data 80 to provide energy modelling services for customers. These energy modelling services will be described in greater detail below. Specifically, energy modelling server 86 is operable to run an energy model 88 (FIG. 12) which simulates the physics and enthalpy of customer premises (i.e., buildings whose HVAC controls are regulated by a controller 22) by modelling energy usage based upon physical attributes 90, historical energy data 92 and usage attributes 94.

Physical attributes 90 include model coefficients that are based upon fixed characteristics of the building site itself (i.e., size of the premise, its age, number of windows, geographical location, etc.). The physical attributes 90 can be populated from information located in customer account data 80 and/or industry standards such as provided by the American Society of Heating, Refrigerating and Air-Conditioning Engineers (ASHRAE). Historical energy data 92 includes model coefficients that are derived from historical energy data patterns (i.e., suspected air leakage on the premise, etc.), as well as historical weather information (temperature, wind speed, etc.) for the geographical region of the premise. Usage attributes 94 include model coefficients that are controlled through the programming of controller 22 (i.e., temperature and humidity set points). Usage attributes 94 could also include coefficients that are primarily economic in nature, such as energy unit cost structures (fixed price, time of use pricing, etc.)

It is contemplated that customer account data 80 may sometimes be missing customer account data 80 that is required to populate a particular physical attribute 90. In such cases, the energy modelling server 86 may be able to make an estimate or guess as to the missing attribute. For example, energy modelling server 86 might be able to derive a value for the missing physical attribute 90 based upon known information from other customers having similar premises or profiles stored in customer account data 80. Premises located near each other geographically, or built at similar times will likely share similar construction properties. Alternatively, energy modelling server 86 may query or data-mine another 3^{rd} party server (not shown) for the missing physical attribute 90. For example, real-estate databases (such as provided by the MLS service) or municipal or property assessment databases (such as provided by MPAC) often contain details about a buildings size, configuration, construction age and building materials. Alternatively, energy modelling server 86 could perform image analysis to derive estimates for the missing physical attribute 90. For example, missing physical attributes 90 relating to window facing, foliage cover or shading could be estimated based upon visual analysis of satellite map data or street-view data.

Controller 22, and in particular, in cooperation with the other components of ICCS 20, can provide climate control functionality beyond that of conventional thermostats through the running of applications 56 on controller 22 and/or the running of applications 56ᵣₑₘₒₜₑ, 56_{PC}, etc. on their respective remote devices 24. Referring back to FIGS. 2 and 3, some of applications 56 running on controller 22 will be briefly discussed. Applications 56 can include an environmental control program (ECP) 96, a weather program 98, an energy use program 100, a remote sensors program 102 and a Configuration program 104. Other programs will occur to those of skill in the art.

ECP 96 is operable to display and regulate environmental factors within a premise such as temperature, humidity and fan control by transmitting control instructions to HVAC equipment 30. ECP 96 displays the current temperature and temperature set point on touch screen display 40. ECP 96 may be manipulated by a user in numerous ways including a scheduling program 106, a vacation override program 108, a quick save override program 110 and a manual temperature adjustment through the manipulation of a temperature slider 112. As shown in FIG. 5, the scheduling program 106 allows a user to customize the operation of HVAC equipment 30 according to a recurring weekly schedule. The weekly schedule allows the user to adjust set-points for different hours of the day that are typically organized into a number of different time periods 114 such as, but not limited to, “Awake”, “Away”, “Home” and “Sleep”. Scheduling program 106 may include different programming modes such as an editor 116 and a wizard 118. Scheduling program 106 may also include direct manipulation of the weekly schedule through various touch gestures (including multi-touch gestures) on image of the schedule displayed on the touch screen display 40. Scheduling program 106 may also include provisions for time of use pricing and/or demand-response events (when optional for the user).

Weather program 98 is operable to provide a user with current and/or future weather conditions in their region. The icon for weather program 98 on the home screen of controller 22 indicates the current local external temperature and weather conditions. This information is provided from an external feed (provided via environmental web service 26), or alternatively, a remote temperature sensor connected directly or indirectly to controller 22 (not shown), or a combination of both an external feed and a remote temperature sensor. In the presently-illustrated embodiment, selecting the weather program 98 replaces the current information on touch screen display 40 with a long-term forecast (i.e., a 7 day forecast) showing the predicted weather for later times and dates. The information for the long term forecast is provided via environmental web service 26.

Energy use program 100 is a program that allows users to monitor and regulate their energy consumption (i.e., electricity use or fossil fuel use). Energy use program 100 can include a real-time display of energy use, regular reports (hourly, daily, weekly, etc.), and provide estimates of projected costs. Energy use program 100 may also allow a user to configure how their HVAC equipment 30 responds to different Demand-Response events issued by their utility. The energy use program 100 may require additional hardware components, such as a smart meter reader in expansion slot/socket 66, as well as smart plugs installed on the premise (not shown). Without the necessary hardware components, the energy use program 100 may be either dimmed out or not present on the touch screen display 40.

Remote sensor program 102 allows users to configure and control remote sensors such as wired or wireless remote temperature, humidity or air flow sensors (not shown) distributed around their premise. When remote sensors are not utilized, then the remote sensor program 84 may be either dimmed out or not present on the touch screen display 40.

Configuration program 104 (alternatively called “Settings”) allows a user to configure many different aspects of their controller 22, including Wi-Fi settings, Reminders and Alerts, Installation Settings, display preferences, sound preferences, screen brightness and Password Protection. Users may also be able to adjust their own privacy settings, as well as configure details pertaining to their HVAC equipment 30, and the physical parameters of their premise relating to energy usage (size, building age, window materials, etc.). Other aspects of controller 22 that can be modified using the configuration program 104 will occur to those of skill in the art.

Controller 22 may include additional applications 56 which operate as back-end applications (i.e., they operate without direct user interaction), such as a reporting application 120, which transmits runtime data to environmental web service 26. In the currently-illustrated embodiment, reporting application 120 periodically transmits data to web service 26 representing five-minute buckets of runtime data. Exemplary runtime data that can be sent includes time and date stamps, programmed mode, measured temperature and humidity (as measured by environmental sensor(s) 54), temperature set points, outdoor temperature, furnace usage (as either a percentage of use during the reporting window, by furnace stage or both), fan usage (as a percentage of the reporting window), wireless signal strength, etc. If a smart meter module is installed in the expansion slot/socket 66, the reporting application 120 can also transmit the metered energy usage and/or energy cost. Other data to be transmitted by reporting application 120 will occur to those of skill in the art. The reporting application 120 is not primarily visible on touch screen display 40, but may be configurable using the Configuration program 120. It is contemplated that either the runtime data transmitted by reporting application 120 and/or an aggregate data reports of the runtime data could also be stored within non-volatile memory 60 on controller 22.

In addition, controller 22 can take advantage of applications and services provided by environmental web service 26. One example, previously described, is the weather feed provided by environmental web service 26 to weather program 98. In the presently-illustrated embodiment, environmental web service 26 offers additional capabilities including use of energy modelling server 86 to users through either controller 22 or remote device 24, providing an opportunity for the user of controller 22 to analyse the energy usage of their HVAC equipment and identify ways to reduce their energy usage and/or energy bills.

To interact with energy modelling server 86, ICCM 20 provides an additional application 56, namely programming simulator 122. Programming simulator 122 is operable to access the analytic capabilities and/or data records of energy model 88 in order to make predictions on how changes to the programming of controller 22 affect energy usage on the premise. Programming simulator 122 may also be able to use energy model 88 to identify modifications to the premise which could reduce energy usage. Programming simulator 122 is an application 56 that can be run on either controller 22 or remote device 24. On controller 22 or on a replica screen shown on a remote device 24, the programming simulator 122 can appear directly on the home screen, or as a button or option selected through another program (such as the scheduling program 106). Programming simulator 122 could also be accessed as a web application on a browser on remote device 24.

Depending on the user interface design of programming simulator 122, as well as its hardware requirements (processing power, memory, etc.), some aspects of the programming simulator 122 may be available only on some components of ICCM 20. For example, a full version of programming simulator 122 could be provided on personal computer 72 (typically as a web application), but only reduced-functionality versions of programming simulator 122 could be provided either on remote device 24 (as a dedicated application), or on controller 22 directly. It is further contemplated that various aspects and functions of programming simulator 122 can be divided between different components of ICCS 20. For example, the simulator user interface 124 of programming simulator 122 can be presented on touch screen display 40 of controller 22, but that the computationally-intensive functions of the programming simulator 122 can occur on energy modelling server 86 with data derived from content databases 78. Alternatively, a programming simulator 122 run on a personal computer 72 could download the necessary data records from content databases 78, but perform the calculations locally. Also alternatively, a programming simulator run on controller 22 could potentially access data records stored in non-volatile memory storage 60.

Referring now to FIG. 6, an embodiment of the programming simulator 122, namely programming simulator 122A is provided. Programming simulator 122A includes a comparatively simplified user interface 124A, making it suitable for the smaller touch screen display 40 of controller 22 or the touch screen display of mobile device 74. Of course, programming simulator 122A could be run as a widget, application or web page on personal computer 72 as well.

The basic UI 124A is able to show a current value 128, which represents the actual energy usage of HVAC equipment 30 as it operated according to the ECP 96. The basic UI 124A also displays at least one changeable parameter 130, which provides a hypothetical change in operating conditions for HVAC equipment 30. The UI 124A is further operable to show a simulator value 132, which represents an estimated energy usage of HVAC equipment 30 based upon a scenario where the HVAC equipment 30 had operated according to the at least one changeable parameter 130. The user of basic simulator 122A is thus able to see the hypothetical impact on their energy usage based upon programming changes or physical changes to their premise. The simulator value 132 may not be initially displayed until after a user has inputted at least one changeable parameter 130, or may simply match the current value 128 until a user has inputted at least one changeable parameter 130.

As currently-illustrated, current value 128 represents the energy usage of HVAC equipment 30 over the past 30 days, although those of skill in the art will recognize that other time periods could be used. For example, current value 128 could represent the energy usage of HVAC equipment 30 over the past 7 days, the previous day, or even the current programming time period 114. In the currently-illustrated embodiment, current value 128 is presented as a vertical bar graph on simulator UI 124A, although those of skill in the art will recognize that other graphical and alphanumeric representations could also be used.

Current value 128 can represent energy usage in different ways. For example, current value 128 can represent an actual quantity of energy (such as BTUs, joules, kilowatt hours, etc.), a physical quantity of fuel (cubic meters of natural gas, litres of heating oil, etc), a derived measurement such as equivalent CO² emissions, or an economic energy usage cost in dollars. Alternatively, current value 128 could indicate the run-time for the HVAC equipment 30, as either a total amount of time or a percentage of the total time period being analysed. Current value 128 could also represent a composite value indicative of two or more measures of energy usage.

For most of the above-discussed representations of current value 128, the actual value is calculated by energy model 88 (on energy modelling server 86), which is subsequently transmitted across network 28 to controller 22. As discussed previously, energy model 88 relies upon physical attributes 90, historical energy data 92 and usage attributes 94. Energy model 88 is operable to access the customer account data 80 and aggregate data warehouse 84 and provide a comparatively accurate estimate of the actual energy usage of HVAC equipment 30 for current value 128. Customer account data is configured to provide the physical attributes 90 for energy model 88, such as the size of the building, building materials, etc. Aggregate data warehouse 94 is configured to provide the historical energy data 92 and usage attributes 94 for energy model 88.

The at least one changeable parameter 130 can include changeable physical parameters 134 and changeable usage parameters 136. Changeable physical parameters 132 represent hypothetical changes to physical attributes of the premise such as changed insulation values, or window materials. Changeable physical parameters 132 can also represent changes to the HVAC equipment 30 such as an improved efficiency furnace or air conditioner. In the presently-illustrated embodiment, the basic UI 124A includes a single changeable physical parameter 134, representing a change to the comparatively air-leakiness of the structure, and provides three values, “leaky”, “average” and “sealed”. Depending on the values located in either physical attributes 90 or historical energy data 92, the basic simulator 22 may be able to determine the pre-existing, default value for the changeable physical parameter 134. By modifying this changeable physical parameter 134, a user can see the predicted effects of the physical change, such as improved weather stripping, gap sealing, etc.

Changeable usage parameters 136 represent hypothetical changes to the programming of controller 22 (resulting in a modification of the usage of HVAC equipment 30), such as modifying temperature set points or adjusting staging values of HVAC equipment 30. In the presently-illustrated embodiment, the basic UI 124A includes a single changeable usage parameter 136, representing a change to the temperature set points of ECP 96, and provides three values, “Comfort”, “Balanced” and “Savings”. Each of these values provides specific temperature set points for the heating and cooling modes of HVAC equipment 30 for each of the time periods 114. Depending on the user's current settings in ECP 96, one of the values for changeable usage parameter 136 may be preselected. By modifying this changeable usage parameter 136, a user can see the effects of increased cooling or heating (“Comfort”) or decreased cooling or heating (“Savings”).

Simulator value 132 provides a hypothetical energy usage value for the operation of HVAC equipment 30 over the time period used by current value 128 (which, in the current embodiment is 30 days). Simulator value 130 represents energy usage in a similar manner is current value 128 (as cost, BTUs, CO², etc.). The actual value of simulator value 132 is calculated by energy model 88 (on energy modelling server 86), and transmitted across network 28 to controller 22. The changes made to the at least one changeable parameter 130 are applied in the energy model 88 to yield the simulator value 132. Changes made to a changeable physical parameter 134 modify a respective physical attribute 90. Changes made to a changeable usage parameter 136 modify a respective usage attribute 94.

The simulator UI 124A can show a simulator value 132 representing hypothetical changes made to either or both of the changeable physical parameter 134 and the changeable usage parameter 136. This change can be represented by UI 124A as an aggregate value, combining the deltas caused by changes to both the changeable physical parameter 134 and the changeable usage parameter 136. Alternatively the simulator value 132 can be broken up and presented by UI 124A as separate values for each of the changeable physical parameter 134 and the changeable usage parameter 136. Alternatively or additionally, the simulator UI 124A can show the difference between simulator value 132 and current value 124A as a percentage of energy usage.

It is also contemplated that the programming simulator 122A can show a simulator value 132 that represents the predicted energy usage of the premise if the premise had been equipped with a non-programmable controller, a controller that did not have different temperature set points across different time periods 114, or had fewer temperature set points across different time periods 114. In this way, the programming simulator 122A provides a retroactive view of energy usage as the current value 124A represents the energy savings provided by ECP 96 on controller 22.

The basic simulator UI 124A can also include a reset button 138. When a user presses the reset button 138, the at least one changeable parameter 130 is returned to its initial value(s) and the simulator value 132 is either adjusted to match current value 128 or is removed entirely from the basic UI 124A.

The basic simulator UI 124A can also include a Program button 140. When a user presses the Program button 140, any changes made to the changeable usage parameter 136 are applied to the ECP 96 as if the user had programmed their HVAC schedule. Thus, the programmed values for each of the time periods 114 in the program schedule will be adjusted to the predetermined set points for each value of the changeable usage parameter 136 (“Comfort, “Balanced” or “Savings”). During the normal operation of reporting application 120, the content databases 78 will be updated accordingly with updated values for usage attributes 94 and historical energy data 92.

The Program button 140 may also be able to commit changes made to changeable physical parameters 134 and update their confirmation in customer account data 80. These changes would represent upgrades that a user has made to the premise, such as fixing leaks, or adding insulation. To prevent a user from inadvertently modifying the physical attributes 90 of their profile, the programming simulator 122A could require additional confirmation from the user before applying the changes. The programming simulator 122A may request additional information from the user to specific the nature of the physical changes made. Unwarranted or exaggerated changes made to changeable physical parameters 134 may be detectable over time by energy model 88. For example, the interval status data 82 over one or more period may indicate that a physical change was not made (or was insufficiently change) and revert the stored physical attribute 90 back to its original or otherwise more suitable value.

Referring now to FIG. 7, a communication sequence chart is provided showing an exemplary method of operation of ICCM 20 while using the programming simulator 122A on controller 22. At step 150, a user initiates the programming simulator 122A on the controller 22.

At step 152, the controller 22 sends a request over network 28 to web service 26 to initialize the energy model 88 on energy modelling server 86.

At step 154, the energy model 88 calculates the current value 128 based upon information stored in content databases 78 (i.e., customer account data 90 and aggregate data warehouse 94).

At step 156, the current value 128 is transmitted by web service 26 over network 28 to controller 22, and displayed on basic UI 124A.

At step 158, a user changes at least one changeable parameter 130 on the basic UI 124A.

At step 160, the changed at least one changeable parameter 130 is transmitted across network 28 to the web service 26 and inputted into energy model 88.

At step 162, the energy model 88 calculates the simulator value 132 based upon information stored in content databases 78 (i.e., customer account data 90 and aggregate data warehouse 94), as modified by the at least one changeable parameter 130.

At step 164, the simulator value 132 is transmitted by web service 26 over network 28 to controller 22, and displayed on basic UI 124A.

This method can be repeated until a user makes another change to the at least one changeable parameter, exits the programming simulator 122A, or commits to a program change (via Program button 140).

Variations to the method have been contemplated. For example, at step 154, the energy model 88 could pre-calculate the simulator value 132 for all the possible combinations of different changeable parameters 130 (there are nine possible combinations shown for the illustrated embodiment). All these values would then be transmitted at step 156 and cached by the programming simulator 122A. Thus, when a user makes an adjustment to one of the changeable parameters 130, there is minimal delay before the selected simulator value 132 is shown. Alternatively, energy model 88 could pre-calculate a key grid of simulator values 132 for the different changeable parameters 130, which could then be interpolated by programming simulator 122A.

Referring now to FIG. 8, a communication sequence chart is provided showing an exemplary method of operation of ICCM 20 while using the programming simulator 122A on remote device 24. At step 170, a user initiates the programming simulator 122A on the remote device 24.

At step 172, the remote device 24 sends a request over network 28 to web service 26 to initialize the energy model 88 on energy modelling server 86.

At step 174, the energy model 88 calculates the current value 128 based upon information stored in content databases 78 (i.e., customer account data 90 and aggregate data warehouse 94).

At step 176, the current value 128 is transmitted by web service 26 over network 28 to remote device 24, and displayed on basic UI 124A.

At step 178, a user changes at least one changeable parameter 130 on the basic UI 124A.

At step 180, the changed at least one changeable parameter 130 is transmitted across network 28 to the web service 26 and inputted into energy model 88.

At step 182, the energy model 88 calculates the simulator value 132 based upon information stored in content databases 78 (i.e., customer account data 90 and aggregate data warehouse 94), as modified by the at least one changeable parameter 130.

At step 184, the simulator value 132 is transmitted by web service 26 over network 28 to remote device 24, and displayed on basic UI 124A.

This method can be repeated until a user makes another change to the at least one changeable parameter, exits the programming simulator 122A, or commits to a program change (via Program button 140). If the user commits to a program change, steps 186 and 188 occur.

At step 186, the remote device transmits the programming change to ECP 96 over network 28 to environmental web service 26.

At step 188, the environmental web service 26 transmits the programming change to controller 22 over network 28.

Variations to the method have been contemplated. For example, at step 174, the energy model 88 could pre-calculate the simulator value 132 for all the possible combinations of different changeable parameters 130 (there are nine possible combinations shown for the illustrated embodiment). All these values would then be transmitted at step 176 and cached by the programming simulator 122A. Thus, when a user makes an adjustment to one of the changeable parameters 130, there is minimal delay before the selected simulator value 132 is shown. Alternatively, energy model 88 could pre-calculate a key grid of simulator values 132 for the different changeable parameters 130, which could then be interpolated by programming simulator 122A.

Referring now to FIG. 9, another embodiment of the programming simulator 122, namely programming simulator 122B is provided. Programming simulator 122B includes a more detailed user interface 124B, making it more attractive for larger mobile devices 74 (such as tablets) or on personal computers 72. Programming simulator 122B provides more detail than the basic simulator described above by breaking energy usage down into individual time periods 114.

The simulator UI 124B is able to display the set points for each of the time periods 114 set in ECP 96. Beside each time period 114, a current value 128B is shown, representing the actual energy usage for that period. As with the previous embodiment, the simulator UI 124B displays at least one changeable parameter 130B, providing a hypothetical changes in operating conditions for HVAC equipment 30. The simulator UI 1248 is further operable to show a simulator value 132B for each time period 114, reflecting changes made to the at least one changeable parameter 130B.

The at least one changeable parameter 130B can include changeable physical parameters 134B and changeable usage parameters 136B. As with the basic simulator, users can quickly select between different predetermined options for the changeable usage parameter 136, namely “Comfort”, “Balanced” and “Savings”. However, with simulator 122B, a user may also be able to directly manipulate the temperature set points for each time period 114 and see an updated simulator value 132B for that particular time period. While the currently-illustrated embodiment contemplates direct manipulation of temperature set points and/or buttons, other UI conventions such as pull-down menus could be used. The simulator UI 124B can also include a simulator summary value 142B which indicates the total change in energy usage based on all the modified time periods 114. As with the previous embodiment, the simulator UI 124B can include a Reset button 138B and a Program button 140B. By pressing the Program button 1408, a user may be able to apply any changes made to ECP 96.

Referring now to FIG. 10, another embodiment of the programming simulator 122, namely programming simulator 122C is provided. Programming simulator 122C includes a more detailed user interface 124C, making it more attractive for larger mobile devices 74 (such as tablets) or on personal computers 72. Similar to the previously-shown embodiments, the simulator UI 124C includes at least one current value 128C and a simulator value 132C. However, the simulator UI 124C provides additional options for changeable physical parameters 134C. Simulator UI 124C provides pull-down menus for different changeable physical parameters 134C including the “Wall Materials”, “Window Materials” and “Insulation R-Values”. As illustrated, programming simulator 122C omits specific buttons or menus for changeable user parameters 136. Instead, for changeable user parameters 136C, the user can directly manipulate the height of the temperature set points for each time period 114. It is further contemplated that programming simulator 122C may be able to export the raw data (such as physical attributes 90, historical energy data 92 and usage attributes 94) for use in a 3^{rd} party spreadsheet for additional analysis.

As with the previous embodiments, the invention is not limited to particular UI conventions. While the previously-illustrated embodiments of programming simulator 122 show multiple time periods 114 simultaneously, it is contemplated that the other presentation formats. For example, the simulator UI could present a single time period 114 onscreen at a time. In this case, a user would move between different time periods 114 and manipulate each one individually. Alternatively, instead of modifying the bar for each time period 114 to adjust the temperature set point, a drop-down menu could be used.

In addition, while the above embodiment describes a user being able to simulate modifications made to the temperature set points for each time period 114, the programming simulator 122 may be able to simulate modifications made to other set points (e.g., fan use, humidification) for each time period 114. Alternatively, the programming simulator 122 may be able to simulate changes made to the start, end or duration of each time period 114. Some embodiments of programming simulator 122 may provide a user interface 124 that is almost identical in appearance and features to the scheduling program 106, being distinguished primarily by the presentation of either simulator values 132 or summary simulator values 142C. It is contemplated that some embodiments of programming simulator 122 may omit the simulator values 132 (in an effort to save space on the simulator UI 124), and provide solely the summary simulator value 142C.

It is contemplated that users of programming simulator 122 will be able to compare their energy usage and/or efficiency with other users in their neighbourhood or are otherwise close by. Programming simulator 122D include a comparison function 144D. Referring now to FIG. 11, the comparison function 144D of programming simulator 122D is shown. Comparison function 144D displays a user's current value 128D for energy usage, but it also shows an average current value 146D for other premises equipped with a controller 22 in a similar geographical area. The average current value 1460 is provided by energy modelling server 86, which can analyse the proximate user records stored in aggregate data warehouse 84. By seeing their current value 128D against the average current value 146D of their neighbours, a user will be able to tell their comparative energy thriftiness, and potentially be spurred to greater energy efficiency. It is further contemplated that the comparison function 144D could compare a user's energy usage and/or efficiency against other individuals who are not located in the same neighbourhood by normalizing the current value 128D and average current value 146D together (i.e., energy used per heating degree per day).

In addition to comparing their current value 128D against that of their neighbours, comparison function 144D may be able to provide an efficiency rating 148D for the user's premise and an average efficiency rating 149D for that of their neighbours. The efficiency rating 148D is a composite value calculated by energy model 88 that indicates the relative efficiency of the premise as reflected in its physical attributes 90 (such as insulation values, air leakiness, furnace efficiency, etc.). The average efficiency rating 149D provides a similar rating for their neighbours and is provided by energy modelling server 86.

ICCN 20 may be able to improve the prediction accuracy of programming simulator 122 and energy model 88 over a period of time by incorporating error correction based upon historical simulator predictions. As discussed previously, the programming simulator 122 provides a current value 128, a simulator value 132 and an optional summary value 142 which indicates the predicated energy usage change (often as a percentage). The current value 128 is likely to be fairly representative as the energy model 88 typically has access to real indicators of energy usage, such as the runtime data provided by reporting application 120. The simulator value 132, however, is dependent upon the forecasting accuracy of energy model 88 to assess the impact of any changes made to the changeable physical parameters 134 and/or the changeable usage parameters 136. It is contemplated that simulator values 132 could be stored either locally within the non-volatile memory storage 60 of controller 22 or within the content databases 78 of energy web service 26. If a user makes modifies their ECP 96 according to a changeable usage parameter 136 (such as by using the Program button 140), the energy model 88 can compare the new current value 128 against the stored simulator value 132 to see if the predicted energy change (as represented by summary value 142) was accurate. As the weather conditions are likely to vary between the two time periods, the stored simulator value 132 will likely need to be normalized to the current time period in order to properly assess the historical accuracy of simulator value 132. If the historical accuracy of simulator value 132 is less than optimal, energy model 88 can incorporate a correction factor or other refinement in its modelling for future predictions for that particular controller 22.

Although an integrated climate control system, and a programming simulator running thereon, has been used to establish a context for disclosure herein, it is contemplated as having wider applicability. Furthermore, the disclosure herein has been described with reference to specific embodiments; however, varying modifications thereof will be apparent to those skilled in the art without departing from the scope of the invention as defined by the appended claims.

What is claimed is:

1. An integrated climate control system, comprising:
a controller operable to control HVAC equipment on a premise, the controller further being operable to transmit runtime data and receive operation instructions across a network;
an environmental web service, the environmental web service being operable to communicate across the network with the controller, the environmental web service being able to receive the runtime data from the controller and further transmit operation instructions to the controller related to the control of the HVAC equipment on the premise across the network; and
wherein the environmental web service is adapted to store the runtime data received from the controller, and is further operable to run an energy model that is operable to calculate a current value of energy usage by the HVAC equipment on the premise over a period of time.

2. The integrated climate control system of claim 1, wherein the environmental web service is operable to transmit the current value across the network to be displayed on one of the controller and a remote device.

3. The integrated climate control system of claim 1, the environmental web service being operable to transmit the current value across the network to be displayed on one of the controller and a remote device; and the integrated climate control system further comprising a programming simulator being adapted to run on the controller or on a remote device in communication with the environmental web service across the network, the programming simulator being able to:
display the current value of energy usage by the HVAC equipment on the premise over the period of time;
display at least one changeable parameter, the at least one changeable parameter relating to energy usage; and
upon selection of the at least one changeable parameter, displaying a simulator value, the simulator value proving an estimate of energy usage over the same period of time as the current value using the selected at least one changeable parameter in the energy model.

4. The integrated climate control system of claim 3, wherein the at least one changeable parameter includes a changeable usage parameter, the changeable usage parameter indicating a change in the usage of the HVAC equipment on the premise.

5. The integrated climate control system of claim 3, wherein the at least one changeable parameter includes a changeable usage parameter, the changeable usage parameter indicating a change in the usage of the HVAC equipment on the premise, including at least one of: a change in a temperature set point, a change in a humidification set point, a change in the staging of HVAC equipment and a change in fan usage.

6. The integrated climate control system of claim 3, wherein the at least one changeable parameter includes a changeable usage parameter, the changeable usage parameter including changes in a temperature set point for the HVAC equipment in both heating and cooling modes.

7. The integrated climate control system of claim 3, wherein the at least one changeable parameter includes a changeable usage parameter, the changeable usage parameter indicating a change in the usage of the HVAC equipment across a plurality of different time periods.

8. The integrated climate control system of claim 3, wherein the at least one changeable parameter includes a changeable usage parameter, the changeable usage parameter indicating a change in a temperature set point of the HVAC equipment across a plurality of different time periods, and where the changeable usage parameter is defined as a value relating to user comfort.

9. The integrated climate control system of claim 3, wherein the at least one changeable parameter includes a changeable usage parameter, the changeable usage parameter indicating a change in the usage of the HVAC equipment on the premise and the programming simulator is operable to provide instructions to the controller to modify operation of the HVAC equipment.

10. The integrated climate control system of claim 3, wherein the at least one changeable parameter includes a changeable physical parameter, the changeable physical parameter indicating a change in at least one of the physical properties of the premise and the HVAC equipment.

11. The integrated climate control system of claim 3, wherein the at least one changeable parameter includes a changeable physical parameter, the changeable physical parameter indicating a change in at least one of the physical properties of the premise and the HVAC equipment, including at least one of: wall materials, window materials, insulation values, furnace efficiency, premise leakiness,

12. The integrated climate control system of claim 3, wherein the at least one changeable parameter includes a changeable physical parameter, the changeable physical parameter indicating a change in at least one of the physical properties of the premise and the HVAC equipment, and
the programming simulator is operable to update customer data records stored by the energy modelling server.

13. The integrated climate control system of claim 3, wherein the current value of energy usage displayed by the programming simulator is calculated by the one of the controller and the remote device running the programming simulator.

14. The integrated climate control system of claim 3, wherein the simulator value of energy usage displayed by the programming simulator is calculated by the energy modelling server.

15. The integrated climate control system of claim 3, wherein
the energy modelling server is operable to calculate a plurality of different simulator values of energy usage and transmit the plurality of different simulator values to the one of the controller and the remote device running the programming simulator; and
the programming simulator is operable to display one of the plurality of different simulator values based upon selection of the at least one changeable parameter.

16. The integrated climate control system of claim 3, wherein the simulator value of energy usage displayed by the programming simulator is calculated by the one of the controller and the remote device running the programming simulator.

17. The integrated climate control system of claim 3, wherein
the energy modelling server is operable to transmit the current value of energy usage from at least one other user at another premise to the one of the controller and the remote device running the programming simulator; and
the programming simulator is operable to display the current value of at least one other user at another premise so that the user can compare their energy usage relative to the of the other user.

18. The integrated climate control system of claim 1, wherein the runtime data transmitted from the controller to environmental server includes smart meter data.

19. The integrated climate control system of claim 1, wherein the runtime data transmitted from the controller to environmental server includes at least one of the following: time and date stamps, programmed mode, measured temperature, measured humidity, temperature set points, outdoor temperature, furnace usage, furnace stage, and fan usage.

20. A programming simulator, adapted to run on one of a controller for HVAC equipment operable to communicate across a network, and a remote device operable to communicate with the controller through the network, the programming simulator being operable to:
display the current value of energy usage by the HVAC equipment on the premise over the period of time;
display at least one changeable parameter, the at least one changeable parameter relating to energy usage; and
upon selection of the at least one changeable parameter, displaying a simulator value, the simulator value proving an estimate of energy usage over the same period of time as the current value using the selected at least one changeable parameter in the energy model.

21. The programming simulator of claim 20, wherein the programming simulator is operable to receive the current value from an energy modelling server via the network.

22. The programming simulator of claim 20, wherein the programming simulator is operable to receive the simulator value from the energy modelling server via the network.

23. The programming simulator of claim 20, wherein the programming simulator is operable to transmit the at least one changeable parameter selected by the user to the energy modelling server via the network.

24. The programming simulator of claim 20, wherein the at least one changeable parameter includes a changeable usage parameter, the changeable usage parameter indicating a change in the usage of the HVAC equipment on the premise.

25. The programming simulator of claim 20, wherein the at least one changeable parameter includes a changeable usage parameter, the changeable usage parameter indicating a change in the usage of the HVAC equipment on the premise, including at least one of: a change in a temperature set point, a change in a humidification set point, a change in staging for the HVAC equipment and a change in fan usage.

26. The programming simulator of claim 20, wherein the at least one changeable parameter includes a changeable usage parameter, the changeable usage parameter including changes in a temperature set point for the HVAC equipment in both heating and cooling modes.

27. The programming simulator of claim 20, wherein the at least one changeable parameter includes a changeable usage parameter, the changeable usage parameter indicating a change in the usage of the HVAC equipment across a plurality of different time periods.

28. The programming simulator of claim 20, wherein the at least one changeable parameter includes a changeable usage parameter, the changeable usage parameter indicating a change in a temperature set point of the HVAC equipment across a plurality of different time periods, and where the changeable usage parameter is defined as a value relating to user comfort.

29. The programming simulator of claim 20, wherein the at least one changeable parameter includes a changeable usage parameter, the changeable usage parameter indicating a change in the usage of the HVAC equipment on the premise and the programming simulator is operable to provide instructions to the controller to modify operation of the HVAC equipment.

30. The programming simulator of claim 20, wherein the at least one changeable parameter includes a changeable physical parameter, the changeable physical parameter indicating a change in at least one of the physical properties of the premise and the HVAC equipment.

31. The programming simulator of claim 20, wherein the at least one changeable parameter includes a changeable physical parameter, the changeable physical parameter indicating a change in at least one of the physical properties of the premise and the HVAC equipment, including at least one of: wall materials, window materials, insulation values, furnace efficiency, premise leakiness,

32. The programming simulator of claim 20, wherein the at least one changeable parameter includes a changeable physical parameter, the changeable physical parameter indicating a change in at least one of the physical properties of the premise and the HVAC equipment, and the programming simulator is operable to update customer data records stored by the energy modelling server.

33. The programming simulator of claim 20, wherein the current value of energy usage displayed by the programming simulator is calculated by the energy modelling server.

34. The programming simulator of claim 20, wherein the current value of energy usage displayed by the programming simulator is calculated by the one of the controller and the remote device running the programming simulator.

35. The programming simulator of claim 20, wherein the simulator value of energy usage displayed by the programming simulator is calculated by the energy modelling server.

36. The programming simulator of claim 20, wherein
the energy modelling server is operable to calculate a plurality of different simulator values of energy usage and transmit the plurality of different simulator values to the one of the controller and the remote device running the programming simulator; and
the programming simulator is operable to display one of the plurality of different simulator values based upon selection of the at least one changeable parameter.

37. The programming simulator of claim 20, wherein the simulator value of energy usage displayed by the programming simulator is calculated by the one of the controller and the remote device running the programming simulator.

38. The programming simulator of claim 20, wherein
the energy modelling server is operable to transmit the current value of energy usage from at least one other user at another premise to the one of the controller and the remote device running the programming simulator; and
the programming simulator is operable to display the current value of at least one other user at another premise so that the user can compare their energy usage relative to the of the other user.

39. The programming simulator of claim 20, wherein the runtime data transmitted from the controller to environmental server includes smart meter data.

40. The programming simulator of claim 20, wherein the runtime data transmitted from the controller to environmental server includes at least one of the following: time and date stamps, programmed mode, measured temperature, measured humidity, temperature set points, outdoor temperature, furnace usage, furnace stage, and fan usage.
